(19) United States
(12) Patent Application Publication
(10) Pub. No.: US 2024/0008449 A1
(43) Pub. Date: Jan. 11, 2024

(54) Pet Water Dispenser

(71) Applicant: SHENZHEN UAH TECHNOLOGY CO., LTD, Shenzhen (CN)

(72) Inventors: Qiang Geng, Shenzhen (CN); Shengbo Lu, Shenzhen (CN); Weixin Luo, Shenzhen (CN); Hao Wang, Shenzhen (CN)

(21) Appl. No.: 17/941,426

(22) Filed: Sep. 9, 2022

(30) Foreign Application Priority Data
Jul. 11, 2022 (CN) 202221782854.6

(51) Int. Cl. A01K 7/02

(52) U.S. Cl. CPC A01K 7/025

(57) ABSTRACT

The application belongs to the technical field of pet equipment, in particular to a pet water dispenser, comprising a filter, a water pump, a drinking dish and a water storage tank with a water storage space; the drinking dish is provided with a water storage sink and a first through hole communicating with the water storage sink, the water pump and the filter are both installed on the water storage tank, and the drinking dish covers the water storage tank; a water inlet of the water pump is communicated with the water storage space, a water outlet of the water pump is communicated with the water storage sink, and the first through hole is communicated with the water storage space through the filter; the water pump, the water storage sink, the first through hole, the filter and the water storage space form a circulating filtration loop for drinking water.

### Cross Reference to Related Applications

The present application claims the benefit of Chinese Patent Application No. 202221782854.6 filed on Jul. 11, 2022, the contents of which are incorporated herein by reference in their entirety.

### TECHNICAL FIELD

The application belongs to the technical field of pet equipment, in particular to a pet water dispenser.

### BACKGROUND

With the development of social economy and the acceleration of urbanization, more and more people like to live in their own small circles, and their interpersonal is communication is becoming less and less. Pets such as cats and dogs can be people's friendly companions. These pets can not only help people get rid of loneliness in life, but also adjust people's mental health. And, for some elderly people who live alone, pets are their life partners. Keeping pets is beneficial to the physical and mental health of the elderly, and the life of the elderly can be fulfilling and enriched through communication with pets.

Pets need to drink water regularly in their daily lives, but people may not necessarily be able to feed water to pets in time. In order to ensure that pets can drink clean and hygienic water at any time, people use the smart pet water dispenser, which can output drinking water for pets to drink when pets approach. Thus the smart pet water dispenser has a broad market prospect. In the prior art, when the smart pet water dispenser detects the arrival of a pet, the water pump would pump water out of the box for the pet to drink. However, when the pet drinks water, food residues in the mouth, hair on the body and the like would likely to fall into the drinking water, resulting in unclean drinking water for the pet.

### SUMMARY

Aiming at the technical problem that the drinking water of the smart pet water dispenser in the prior art is not clean, the application provides a pet water dispenser.

The pet water dispenser includes a filter, a water pump, a drinking dish and a water storage tank with a water storage space; the drinking dish is provided with a water storage sink and a first through hole communicating with the water storage sink, the water pump and the filter are both installed on the water storage tank, and the drinking dish covers the water storage tank; a water inlet of the water pump is communicated with the water storage space, a water outlet of the water pump is is communicated with the water storage sink, and the first through hole is communicated with the water storage space through the filter; the water pump, the water storage sink, the first through hole, the filter and the water storage space form a circulating filtration loop for drinking water.

Optionally, the pet water dispenser further includes a battery and an electronic control housing provided with an internal space, wherein both the battery and the water pump are installed in the internal space, and case of the battery is installed on an outer wall of the water storage tank.

Optionally, an insertion slot is arranged on the outer wall of the water storage tank, and the electronic control housing is inserted into the insertion slot.

Optionally, the pet water dispenser further includes a water inlet joint, a joint and a water outlet joint arranged on the electronic control housing; an inlet of the water inlet joint is communicated with bottom of the water storage space, an outlet of the water inlet joint is communicated with an inlet of the joint through a communication pipe, an outlet of the joint is communicated with the water inlet of the water pump, the water outlet of the water pump is communicated with an inlet of the water outlet joint, and an outlet of the water outlet joint is communicated with the water storage sink.

Optionally, the pet water dispenser further includes a first filter part installed in the water inlet joint.

Optionally, the pet water dispenser further includes a controller and a sensor for sensing pets approaching the pet water dispenser, the sensor is installed on an outer wall of the electronic control housing, the controller is installed in the internal space, and the controller is electrically connected with the water pump, the battery and the sensor.

Optionally, the filter includes a second filter part and a mounting base installed on the water storage tank, the mounting base is provided with a receiving is groove and a second through hole communicating with the receiving groove, the second filter part is installed in the receiving groove, the first through hole communicates with the receiving groove, and the receiving groove communicates with the water storage space through the second through hole.

Optionally, the mounting base includes a base body and a first hitch arm connected with the base body, and the receiving groove and the second through hole are both arranged on the base body; the base body is hitched to an opening edge of the water storage tank through the first hitch arm, and the base body is positioned in the water storage space.

Optionally, a second hitch arm is arranged on the drinking dish, and the drinking dish is hitched to the opening edge of the water storage tank through the second hitch arm.

Optionally, there is a preset water storage distance between the first through hole and the bottom of the water storage sink.

In the present application, the water pump, water storage sink, first through hole, filter and water storage space form a circulating filtration loop for drinking water. Specifically, the water pump pumps the drinking water from the water storage space and inputs it into the water storage sink of the drinking dish, a part of the water in the drinking dish is left in the water storage sink for pets to drink, and another part of the water in the drinking dish flows back into the water storage space through the first through hole and the filter. In the process of drinking water circulation, the filter can filter out food residues, hair and the like that fall into the drinking water when pets drink water. Furthermore, the filter may also be provided with a disinfectant, so that the filter can play a role in sterilizing the drinking water, thus ensuring the cleanliness of the drinking water output by the pet water dispenser, and ensuring healthy drinking water for pets. In addition, the pet water dispenser has the advantages of simple structure and low manufacturing cost.

### BRIEF DESCRIPTION OF THE DRAWINGS

The present application is further illustrated with reference to the following drawings and embodiments.

FIG. 1 is a structural schematic diagram of a pet water dispenser provided by an embodiment of the present application;

FIG. 2 is a structural schematic diagram of a filter and a drinking dish of a pet water dispenser provided by an embodiment of the present application installed on a water storage tank;

FIG. 3 is a structural schematic diagram of a drinking dish of a pet water dispenser provided by an embodiment of the present application;

FIG. 4 is a structural schematic diagram of a filter of a pet water dispenser provided by an embodiment of the present application;

FIG. 5 is a partial structural diagram of a pet water dispenser provided by an embodiment of the present application;

FIG. 6 is a cross-sectional view of FIG. 4.

Reference signs in the figures are as follows:

1. Filter; 11. Second filter part; 12. Mounting base; 121. Base body; 1211. Receiving groove; 122. First hitch arm; 2. Water pump; 3. Drinking dish; 31. Water storage sink; 32. First through hole; 33. Second hitch arm; 4. Water storage tank; 41. Insertion slot; 5. Battery; 6. Electronic control housing; 61. Internal space; 62. Water outlet joint; 63. Joint; 64. Water inlet joint; 7. Sensor.

### DETAILED DESCRIPTION OF DISCLOSED EMBODIMENTS

In order to make the beneficial effects, technical solutions and technical problems solved by the present application clearer, the present application will be further illustrated in detail with reference to the drawings and embodiments. It should be understood that the specific embodiments described here are merely for is illustrating the present application, but not for limiting the present application.

It should be understood that the directions or positional relationships indicated by the terms “upper”, “lower”, “left”, “right”, “front”, “back” and “middle” are based on the directions or positional relationships shown in the drawings, only for convenience of describing the present application and simplifying the descriptions, instead of indicating or implying that the device or element must have a specific orientation, be constructed or operated in a specific orientation, and therefore cannot be understood as a limitation of the present application.

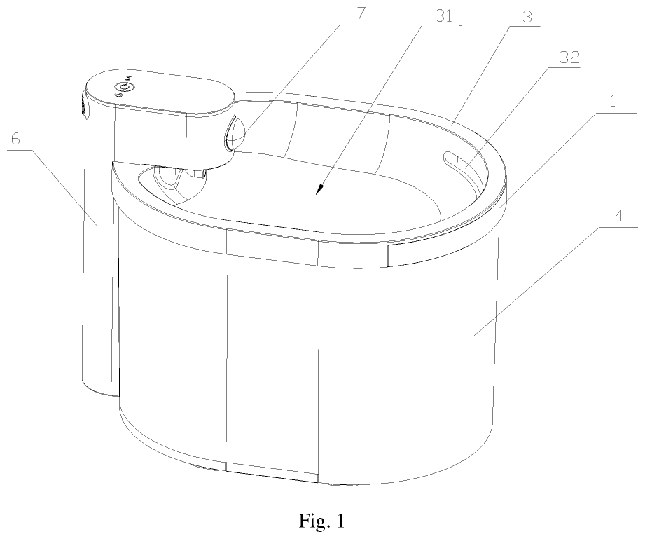

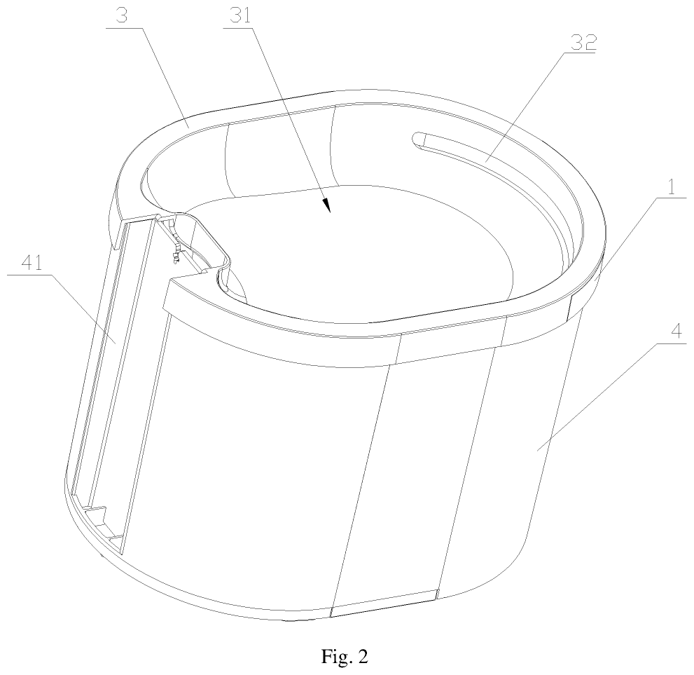

As shown in FIGS. 1 to 4, the pet water dispenser provided by embodiments of the present application includes a filter 1, a water pump 2, a drinking dish 3 and a water storage tank 4 with a water storage space (not shown in the figures); the drinking dish 31 is provided with a water storage sink 31 and a first through hole 32 communicating with the water storage sink 31, the water pump 2 and the filter 1 are both installed on the water storage tank 4, and the drinking dish 3 covers the water storage tank 4; a water inlet of the water pump 2 is communicated with the water storage space, a water outlet of the water pump 2 is communicated with the water storage sink 31, and the first through hole 32 is communicated with the water storage space through the filter 1; the water pump 2, the water storage sink 31, the first through hole 32, the filter 1 and the water storage space form a circulating filtration loop for drinking water. Understandably, the drinking dish 3 covers the top of the water storage tank 4, the filter 1 is arranged in the internal space 61, and the first through hole 32 may be designed as a circular hole structure, an arc-shaped through groove structure and the like according to actual requirements.

Further, there is a preset water storage distance between the first through hole 32 and the bottom of the water storage sink 31, which can be determined according to actual requirements. That is, the first through hole 32 is arranged on the inner is side wall of the drinking dish 3, but not on the bottom of the drinking dish 3. Thereby, after the water pump 2 pumps drinking water from the water storage space and inputs it into the drinking dish 3, a part of the drinking water in the drinking dish 3 flows back into the water storage space through the first through hole 32 and the filter 1, and the other part of the drinking water in the drinking dish 3 is left in the water storage sink 31 for pets to drink.

In the present application, the water pump 2, water storage sink 31, first through hole 32, filter 1 and water storage space form a circulating filtration loop for drinking water. Specifically, the water pump 2 pumps the drinking water from the water storage space and inputs it into the water storage sink 31 of the drinking dish 3, a part of the water in the drinking dish 3 is left in the water storage sink 31 for pets to drink, and another part of the water in the drinking dish 3 flows back into the water storage space through the first through hole 32 and the filter 1. In the process of drinking water circulation, the filter 1 can filter out food residues, hair and the like that fall into the drinking water when pets drink water. Furthermore, the filter 1 may also be provided with a disinfectant, so that the filter can play a role of disinfection and sterilization of drinking water, thus ensuring the cleanliness of the drinking water output by the pet water dispenser, and ensuring healthy drinking water for pets. Moreover, the pet water dispenser has the advantages of simple structure and low manufacturing cost.

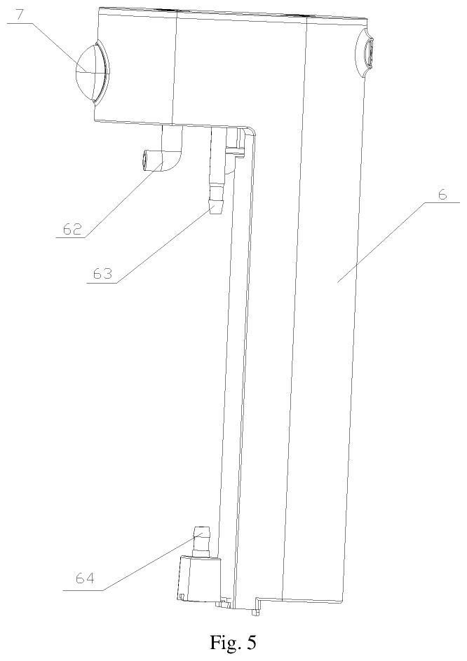

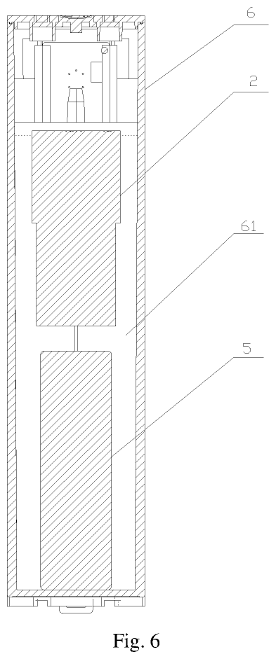

In an embodiment, as shown in FIGS. 5 and 6, the pet water dispenser further includes a battery 5 and an electronic control housing 6 provided with an internal space 61, both the battery 5 and the water pump 2 are installed in the internal space 61, and the case of the battery 5 is installed on the outer wall of the water storage tank 4. Understandably, the electrical devices such as the water pump 2 and battery 5 are arranged in the internal space 61 of the electronic control housing 6, which avoids the interference of the drinking water in the water storage space and the water storage sink 31 on the electrical devices, thus improving the waterproof level of the pet water dispenser and prolonging the service life of the pet water is dispenser.

In an embodiment, as shown in FIGS. 1, 2 and 5, an insertion slot 41 is arranged on the outer wall of the water storage tank 4, and the electronic control housing 6 is inserted into the insertion slot 41. Understandably, the lower end of the electronic control housing 6 has an insertion fitting structure, and the lower end of the electronic control housing 6 is inserted into the insertion slot 41. In this embodiment, the design of the insertion slot 41 improves the convenience of disassembly and assembly between the electronic control housing 6 and the water storage tank 4.

Further, the electrical devices such as the water pump 2, battery 5, and controller are arranged in the internal space 61 of the electronic control housing 6. The electronic control housing 6 is inserted into the insertion slot 41 of the water storage tank 4, thus realizing the design effect of water-electricity separation for the pet water dispenser, avoiding the interference of the drinking water in the water storage space and the water storage sink 31 on the electrical devices in the internal space 61, improving the waterproof level of the pet water dispenser and prolonging its service life.

In an embodiment, as shown in FIG. 5, the pet water dispenser further includes a water inlet joint 64, a joint 63 and a water outlet joint 62 arranged on the electronic control housing 6; an inlet of the water inlet joint 64 is communicated with bottom of the water storage space, an outlet of the water inlet joint 64 is communicated with an inlet of the joint 63 through a communication pipe (not shown), an outlet of the joint 63 is communicated with the water inlet of the water pump 2, the water outlet of the water pump 2 is communicated with an inlet of the water outlet joint 62, and an outlet of the water outlet joint 62 is communicated with the water storage sink 31. Understandably, the communication pipe may be a catheter made of soft silica gel. The water inlet joint 64 is arranged below the electronic control housing 6, and both the joint 63 and the water outlet joint 62 are is arranged above the electronic control housing 6. Specifically, the water inlet of the water pump 2 sequentially pumps the drinking water in the water storage space through the joint 63, the communication pipe and the water inlet joint 64, and the water outlet of the water pump 2 outputs the drinking water to the water storage sink 31 through the water outlet joint 62. In this embodiment, the pet water dispenser has the advantages of simple structure, low manufacturing cost as well as convenient assembly and disassembly.

In an embodiment, the pet water dispenser further includes a first filter part (not shown) installed in the water inlet joint 64. Understandably, the first filter part includes, but is not limited to, a filter screen, etc., which can prevent impurities from entering the water pump 2 and causing blockage, and thus further improve the cleanliness of the drinking water output from the water pump 2 to the drinking dish 3.

In an embodiment, as shown in FIGS. 1 and 5, the pet water dispenser further includes a controller (not shown) and a sensor 7 for sensing pets approaching the pet water dispenser, the sensor 7 is installed on an outer wall of the electronic control housing 6, the controller is installed in the internal space 61, and the controller is electrically connected with the water pump 2, the battery 5 and the sensor 7. Understandably, the sensor 7 includes but is not limited to a pyroelectric infrared sensor 7, a camera and the like. Specifically, when the sensor 7 senses that a pet is getting close to the pet water dispenser, the water pump 2 is controlled to be turned on, and pumps the drinking water from the water storage space into the drinking dish 3 for the pet to drink. In addition, the controller can also control the water pump 2 to regularly pump the water from the water storage space into the drinking dish 3, i.e., the pet water dispenser is in a filtering cycle mode at regular intervals, thus ensuring the cleanliness of the drinking water in the drinking dish 3.

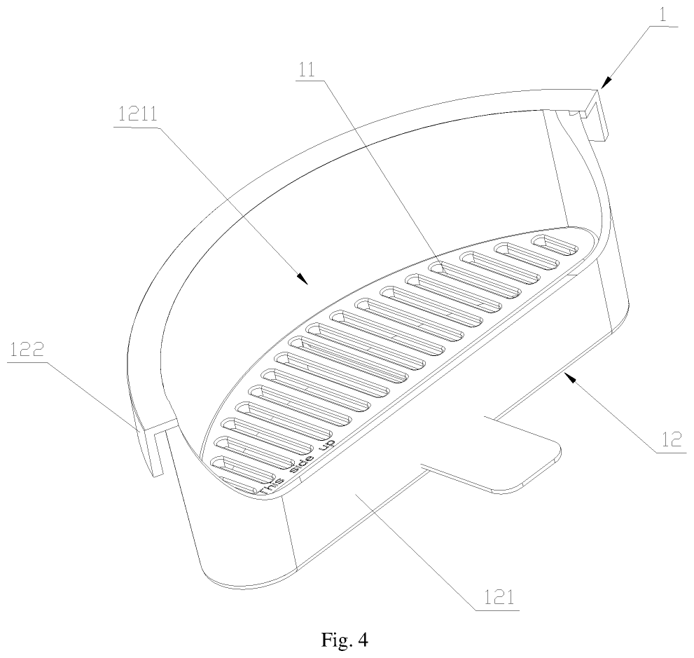

In an embodiment, as shown in FIG. 4, the filter 1 includes a second filter part 11 and a mounting base 12 installed on the water storage tank 4. The mounting is base 12 is provided with a receiving groove 1211 and a second through hole communicating with the receiving groove 1211, and the second filter part 11 is installed in the receiving groove 1211. The first through hole 32 communicates with the receiving groove 1211, and the receiving groove 1211 communicates with the water storage space through the second through hole. Understandably, the second filter part 11 is arranged below the first through hole 32. First, the second filter part 11 is installed in the receiving groove 1211, and then the mounting base 12 is installed on the water storage tank 4, thus completing the installation of the filter 1.

In an embodiment, as shown in FIGS. 1 and 4, the mounting base 12 includes a base body 121 and a first hitch arm 122 connected to the base body 121, and the receiving groove 1211 and the second through hole are both arranged on the base body 121. The base body 121 is hitched to the opening edge of the water storage tank 4 through the first hitch arm 122, and the base body 121 is positioned in the water storage space. Understandably, a first hitch groove is formed between the base body 121 and the first hitch arm 122, and the opening edge of the water storage tank 4 is inserted into the first hitch groove. In this embodiment, the mounting base 12 is detachably installed on the water storage tank 4 through the first hitch arm 122, which is convenient for users to clean and replace the second filter part 11. Moreover, the filter 1 is easy to be assembled and disassembled.

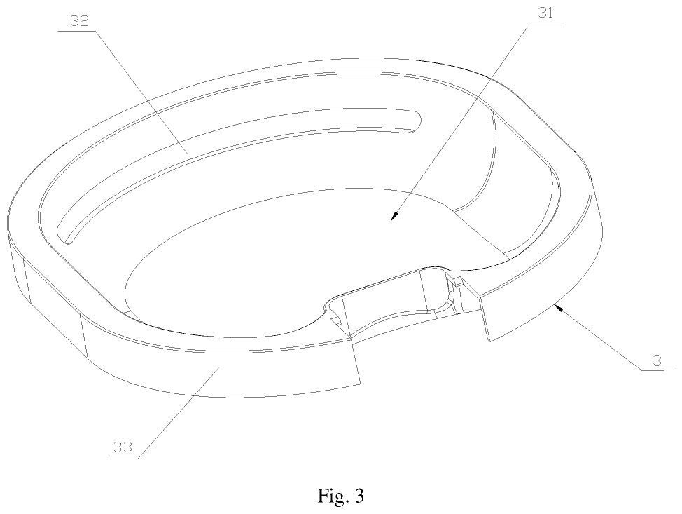

In an embodiment, as shown in FIGS. 1 and 3, the drinking dish 3 is provided with a second hitch arm 33, and the drinking dish 3 is hitched to the opening edge of the water storage tank 4 through the second hitch arm 33. Understandably, the drinking dish 3 detachably covers the water storage tank 4 through the second hitch arm 33, which ensures the tightness of the water storage space and facilitates the disassembly and assembly of the drinking dish 3, thereby facilitating the cleaning of the drinking dish 3 and the water storage tank 4.

The above are only preferred embodiments of the pet water dispenser of the present application, and are not intended to limit the present application. Any is modifications, equivalent substitutions and improvements made within the spirit and principle of the present application shall be included in the protection scope of the present application.

What is claimed is:

1. A pet water dispenser, comprising a filter, a water pump, a drinking dish and a water storage tank with a water storage space; the drinking dish is provided with a water storage sink and a first through hole communicating with the water storage sink, the water pump and the filter are both installed on the water storage tank, and the drinking dish covers the water storage tank; a water inlet of the water pump is communicated with the water storage space, a water outlet of the water pump is communicated with the water storage sink, and the first through hole is communicated with the water storage space through the filter; the water pump, the water storage sink, the first through hole, the filter and the water storage space form a circulating filtration loop for drinking water.

2. The pet water dispenser of claim 1, further comprising a battery and an electronic control housing provided with an internal space, wherein both the is battery and the water pump are installed in the internal space, and case of the battery is installed on an outer wall of the water storage tank.

3. The pet water dispenser of claim 2, wherein an insertion slot is arranged on the outer wall of the water storage tank, and the electronic control housing is inserted into the insertion slot.

4. The pet water dispenser of claim 2, further comprising a water inlet joint, a joint and a water outlet joint arranged on the electronic control housing; an inlet of the water inlet joint is communicated with bottom of the water storage space, an outlet of the water inlet joint is communicated with an inlet of the joint through a communication pipe, an outlet of the joint is communicated with the water inlet of the water pump, the water outlet of the water pump is communicated with an inlet of the water outlet joint, and an outlet of the water outlet joint is communicated with the water storage sink. The pet water dispenser of claim 4, further comprising a first filter part installed in the water inlet joint.

6. The pet water dispenser of claim 2, further comprising a controller and a sensor for sensing pets approaching the pet water dispenser, wherein the sensor is installed on an outer wall of the electronic control housing, the controller is installed in the internal space, and the controller is electrically connected with the water pump, the battery and the sensor.

7. The pet water dispenser of claim 1, wherein the filter comprises a second filter part and a mounting base installed on the water storage tank, the mounting is base is provided with a receiving groove and a second through hole communicating with the receiving groove, the second filter part is installed in the receiving groove, the first through hole communicates with the receiving groove, and the receiving groove communicates with the water storage space through the second through hole.

8. The pet water dispenser of claim 7, wherein the mounting base comprises a base body and a first hitch arm connected with the base body, and the receiving groove and the second through hole are both arranged on the base body; the base body is hitched to an opening edge of the water storage tank through the first hitch arm, and the base body is positioned in the water storage space.

9. The pet water dispenser of claim 1, wherein the drinking dish is provided with a second hitch arm, and the drinking dish is hitched to the opening edge of the water storage tank through the second hitch arm.

10. The pet water dispenser of claim 1, wherein there is a preset water storage distance between the first through hole and bottom of the water storage sink.

11. The pet water dispenser of claim 2, wherein there is a preset water storage distance between the first through hole and bottom of the water storage sink.

12. The pet water dispenser of claim 3, wherein there is a preset water storage distance between the first through hole and bottom of the water storage sink.

13. The pet water dispenser of claim 4, wherein there is a preset water storage distance between the first through hole and bottom of the water storage sink.

14. The pet water dispenser of claim 5, wherein there is a preset water storage distance between the first through hole and bottom of the water storage sink.

15. The pet water dispenser of claim 6, wherein there is a preset water storage distance between the first through hole and bottom of the water storage sink.

16. The pet water dispenser of claim 7, wherein there is a preset water storage distance between the first through hole and bottom of the water storage sink.

17. The pet water dispenser of claim 8, wherein there is a preset water storage distance between the first through hole and bottom of the water storage sink.

18. The pet water dispenser of claim 9, wherein there is a preset water storage distance between the first through hole and bottom of the water storage sink.
